(19) United States
(12) Patent Application Publication
(10) Pub. No.: US 2025/0181809 A1
(43) Pub. Date: Jun. 5, 2025

(54) OPTIMIZING THE ERROR CHECKING LOGIC IN A PROCESSOR

(71) Applicant: International Business Machines Corporation, Armonk, NY (US)

(72) Inventors: Karthik V. Swaminathan, Mount Kisco, NY (US); Douglas Balazich, Poughkeepsie, NY (US); Ramon Bertran Monfort, New Orleans, LA (US); Arvind Haran, Liberty Hill, TX (US); Alper Buyuktosunoglu, White Plains, NY (US); Hans Mikael Jacobson, White Plains, NY (US); Matthias Pflanz, Holzgerlingen (DE); Pradip Bose, Yorktown Heights, NY (US)

(21) Appl. No.: 18/528,878

(22) Filed: Dec. 5, 2023

(51) Int. Cl. G06F 30/3315; G06F 115/10; G06F 119/12

(52) U.S. Cl. CPC G06F 30/3315; G06F 2115/10; G06F 2119/12

(57) ABSTRACT

An approach for optimizing error-checking logic in a processor design is disclosed. The approach includes performing a static analysis on the processor design, wherein the processor design includes one or more latches and one or more checkers and generating a bipartite graph mapping between the one or more latches and the one or more checkers. The approach also determines checker set cover based on the mapping and preselecting timing critical checkers. The approach also determines redundant checkers based on checker activity and eliminate redundant checkers. Finally, the approach determines whether convergence criteria has been met.

### STATEMENT REGARDING PRIOR DISCLOSURES BY THE INVENTOR OR A JOINT INVENTOR

The following disclosure(s) are submitted under 35 U.S.C. § 102(b)(1)(A): DISCLOSURE(S):
(1) SWAMINATHAN et al., “Characterization and Exploration of Latch Checkers for Efficient RAS Protection”, 2023 53rd Annual IEEE/IFIP International Conference on Dependable Systems and Networks—Supplemental Volume (DSN-S), 27-30 Jun. 2023, DOI: 10.1109/DSN-S58398.2023.00026, Porto, Portugal, 7 pages.

### BACKGROUND

The present invention relates generally to IC (integrated circuit) designs, and more particularly to optimizing error checking logic related to a processing unit.

IC designer may utilize a tool based on RTL (Register Transfer Level) to minimize redundancy with latches and optimize RAS (Reliability, Availability and Serviceability) requirement. RTL is a representation of the digital circuit at the abstract level. Tools, such as Verilog and VHDL can be leveraged to represent the logic/functionality of the CPU design by using a simple text entry language (programming).

### SUMMARY

Aspects of the present invention disclose a method, computer program product and system for optimizing error-checking logic in a processor design. The device may include, performing static analysis on the processor design, wherein the processor design includes one or more latches and one or more checkers; generating mapping between the one or more latches and the one or more checkers; determining checker set cover based on the mapping; preselecting timing critical checkers from the one or more checkers; determining redundant checkers based on checker activity; eliminating redundant checkers; and determining whether convergence criteria has been met.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high-level overview of the IC design environment, designated as 100, and the equivalent graphics representation in accordance with an embodiment of the present invention;

FIG. 2 is process overview of IC design environment 100, designated as 200, in accordance with an embodiment of the present invention;

FIG. 3 is a diagram illustrating bipartite graph mapping of latch to checker connection, designated as 300, in accordance with an embodiment of the present invention;

FIG. 4 is a high-level flowchart illustrating the process of IC design environment 100, designated as 400, in accordance with one embodiment of the present invention;

FIG. 5 is a high-level flowchart illustrating the process of IC component 111, designated as 500, in accordance with another embodiment of the present invention; and

FIG. 6 depicts a block diagram, designated as 600, of components of a computer capable of executing IC component 111 within the IC design environment 100, in accordance with an embodiment of the present invention.

### DETAILED DESCRIPTION

There are current challenges and issues in regard to designing a processor where the requirements may include a targeted level of RAS (reliability, availability, serviceability). For example, relating to RAS level, designer may have to contend with parity and error protection and optimizing latch sizing.

Other challenges can include, but is not limited to, i) scalability of tools to large cores and chips. For example, the runtime of the tool to analyze checker coverage increases exponentially with number of latches making it difficult to scale to macros/cores over a few 100 K latches, ii) finding list of representative workloads. For example, there are limitations to using single instruction benchmarks (cache/LLC coverage, speculative paths, etc.) and iii) proving the selected checker list is close to the theoretical optimal. For example, the optimal checker selection problem is NP-Hard and computationally infeasible which requires heuristics (presented as various embodiments) to be implemented in a real system. Although, the proposed embodiments work well in most cases, the approximation algorithms are 2-approximate, which means that it is possible for the theoretical optimal to be twice better than the approximation.

Those same challenges can introduce the following issues, i) radiation-induced soft errors continue to be one of the primary sources of failures in a processor. These errors are exacerbated by technology scaling and low Qcrit, ii) RAS level may not be achieved, iii) significant area/power/performance overhead associated with the existing techniques, iv) redundant RAS protection at the process level when the units/macros written by different designer and v) Current tools are purely static and do not reflect the actual application-level derating.

Although, current tools may allow processor design, via RTL, which may indicate the latches and checkers that exists in the design along with the level of checking (analysis). There are no existing tools that can address the above challenges and issues with processor design.

Embodiments of the present invention address the above challenges and issues by providing an approach. The approach includes analyzing the list of latches and the corresponding checkers. The approach then maps the latches to the checkers by leveraging the use of bipartite graphs to carry out an optimization process. As part to the optimization process, redundant latches can be identified and deactivated. Then, process can repeat iteratively until a certain design criterion (from the user) is met.

Some advantages of the current embodiment, includes, but is not limited to, i) eliminating redundant latch parity checkers preserving the original level of RAS coverage (i.e., can reduce the number of checkers while preserving the original RAS coverage), ii) determining a unified set of checkers for timing critical and SER-vulnerable latches (termed as static optimization), iii) eliminating latch checkers corresponding to inactive latches at runtime (termed as runtime optimization), iv) achieving an optimal checker configuration by running successive static and runtime optimization steps until convergence, v) the current technique can be applied across all homogeneous and heterogeneous computing platforms and in essence, can be applied alongside this invention, vi) optimizes timing and parity checkers by also taking into account workload dependence of checker utilization. This can enable a much higher reduction in RAS logic, vii) enable significant area/power savings at design time.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

### Definitions

The word “processor” will be used throughout the application. This term denotes a specialized IC (integrated circuit) chip that has, at least the following characteristics but not limited to, i) logic checking, ii) parity checking and iii) error checking. The processor may include, CPU (central processing unit), GPU (graphic processing unit) and other chips with the aforementioned characteristics.

The term, “NP-hard”, denotes a computer science term dealing with prime factorization where current solutions do not exist (i.e., not practical to be done in polynomial time).

The term, “nodes” and “vertices” may be used interchangeably as it pertains to bipartite graph and mapping, by using bipartite graph, between checkers and latches.

### Figures

The present invention will now be described in detail with reference to the Figures.

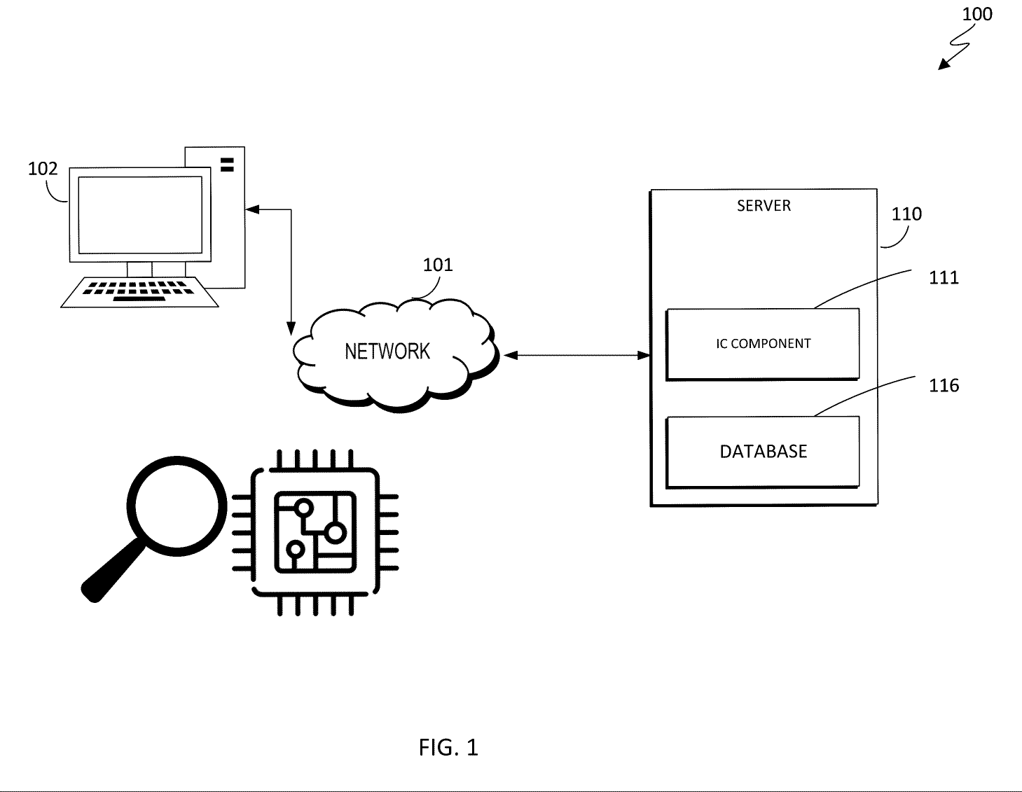

FIG. 1 is a functional block diagram illustrating a high-level overview of the IC design environment, designated as 100, and the equivalent graphics representation in accordance with an embodiment of the present invention.

IC design environment 100 includes the following elements, network 101, computer 102 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, computer 102 and other computing devices (not shown) within IC design environment 100.

Computer 102 is a computing device that can include a CPU or any IC designer software. Computer 102 can also perform various test functionality on the IC design.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating with other computing devices (not shown) within IC design environment 100 via network 101. In another embodiment, server 110 represents a computing system utilizing clustered computers and components (e.g., database server computers, application server computers, etc.) that act as a single pool of seamless resources when accessed within IC design environment 100.

Embodiment of the present invention can reside on server 110 or computer 102. Server 110 includes IC component 111 and database 116.

Server 110 includes the following elements, IC component 111 and database 116.

As is further described herein below, IC component 111 of the present invention provides the capability of eliminating redundant latch parity checkers while preserving the original level of RAS coverage for a given IC design. The high-level capability of IC component 111 can be summarized as follows, i) generating a static list of latches and corresponding checkers, ii) generating a bipartite graph mapping between the latches and checkers, which can include checking level, iii) preselecting timing critical checkers iv) determining which checkers are critical and/or determining which latches are inactive, v) removing checkers that corresponds to derated latches (i.e., inactive latches) and vi) repeating steps i) to iv) until a convergence criteria (predetermined and selectable by the user/designer) is met.

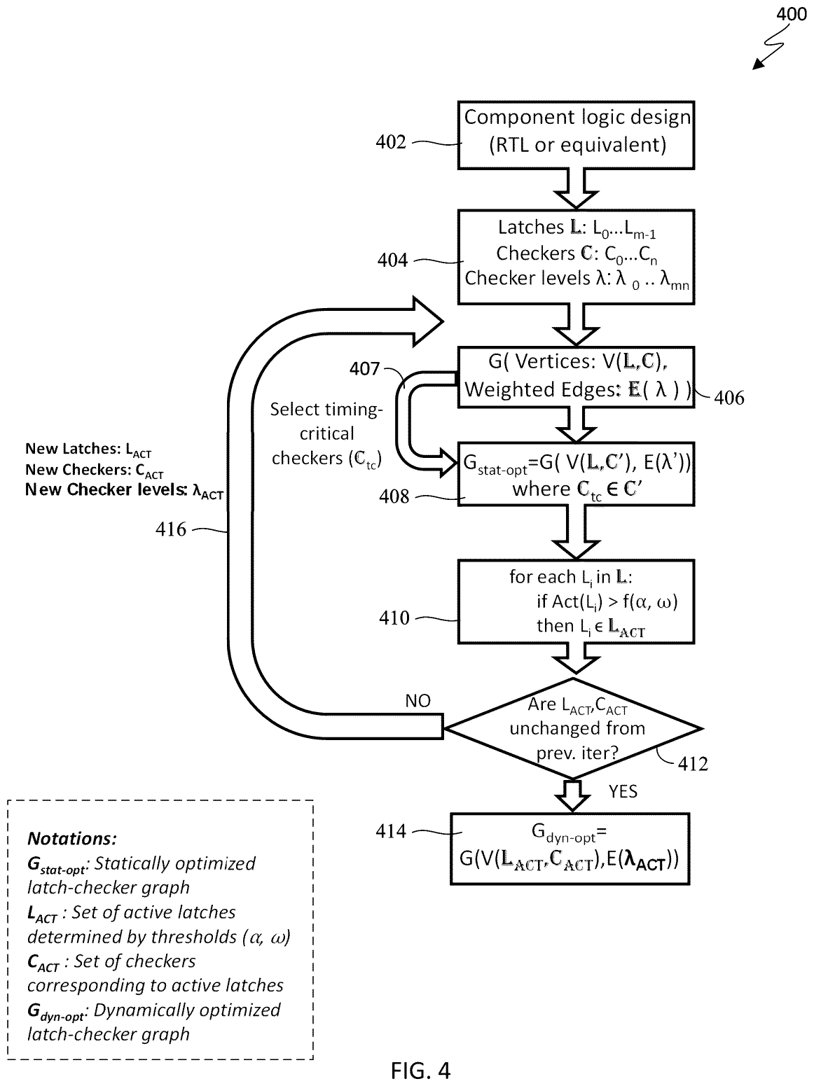

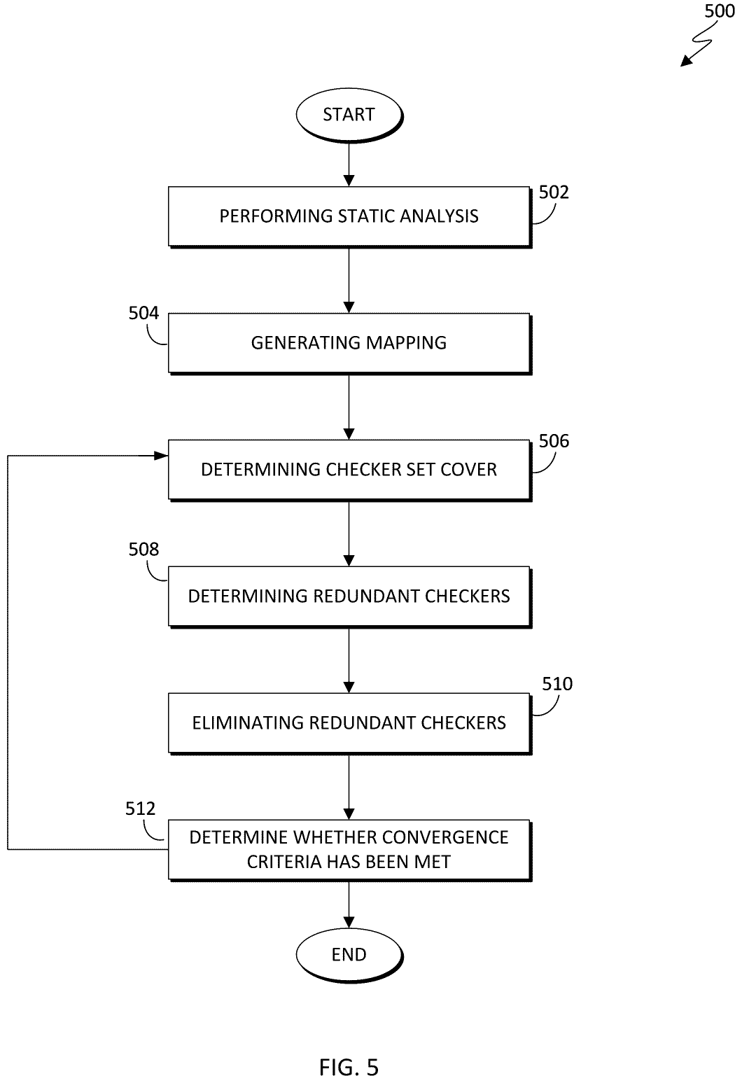

The steps/process of IC component 111 will be described in greater details as it relates to FIG. 4 and FIG. 5.

Database 116 is a repository for data used by IC component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within IC design environment 100, provided that IC component 111 has access to database 116. Database 116 may store information associated with, but is not limited to, knowledge corpus, calculation technique as it relates to polynomials in real time, processor design, bipartite graph optimization techniques, design settings and criteria, scalability of tools to large cores and chips, a list of representative workloads and scenarios, heuristics for calculations and specifications of all processors/ICs.

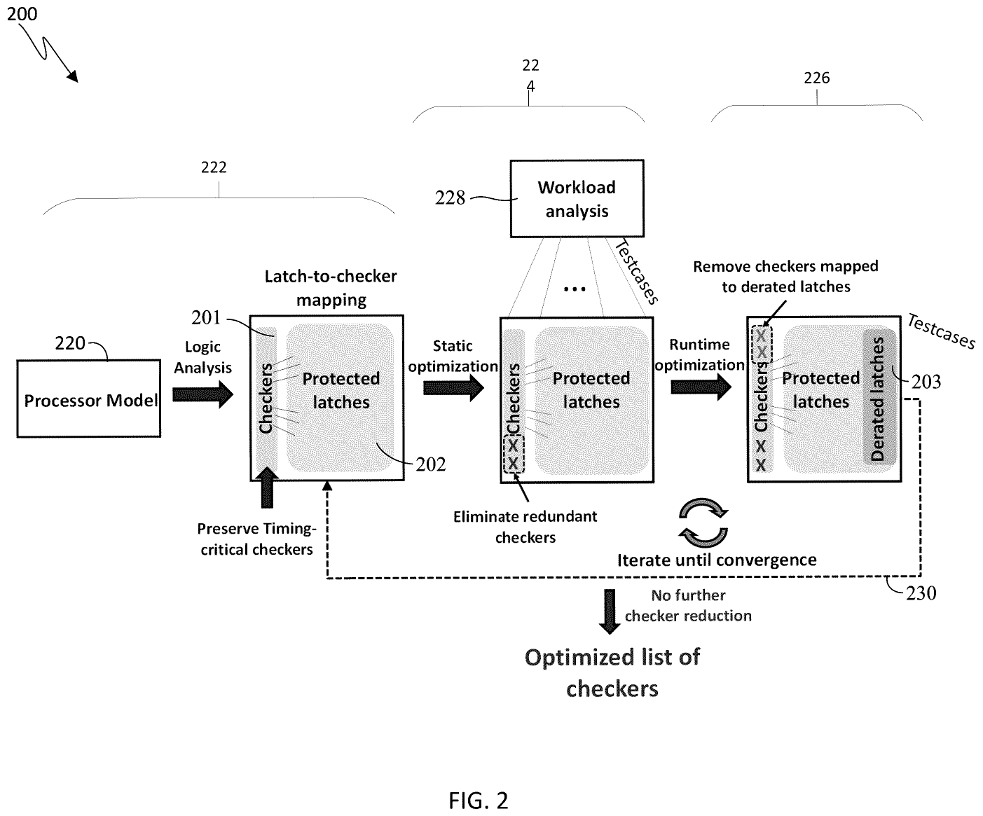

FIG. 2 is system overview of IC design environment 100, designated as 200, in accordance with an embodiment of the present invention. A logic analysis is performed on a plurality of checkers (i.e., 201) and corresponding latches is performed at block 220 (i.e., processor model) and bracket 222. These latches can include protected latches (i.e., 202) and the checkers can include timing critical checkers. During the step of 222, checkers and latches are mapped and analyzed (i.e., logic analysis) via bipartite graphs. During this step, timing-critical checkers are included and protected latches are identified.

In bracket 224, the analysis (i.e., static optimization) may involve the process of minimizing redundant checkers by removing those checkers. Furthermore, the step may include a workload analysis (block 228) which can involve the use of various test cases.

In bracket 226, the analysis may involve the process of optimizing the IC design during a simulated runtime scenario. This may also involve, i) identifying derated latches and ii) the removal of checkers that were mapped to derated latches. It is noted that derated latches (i.e., 203) can belong to the set of protected latches but not necessarily be entirely included within the set. Furthermore, the step may involve the use of various test cases as well.

Furthermore, there is a “feedback” loop (i.e., 230) from bracket 226 as an input into the bracket 222. The feedback loop allows the designer/user to eliminate and/or optimize the checkers. For example, one result of the workload analysis, embodiment of the present invention can remove checkers that are correlated to the derated latches. It is noted that workload-dependent latch activity can further be used to prune the checking logic.

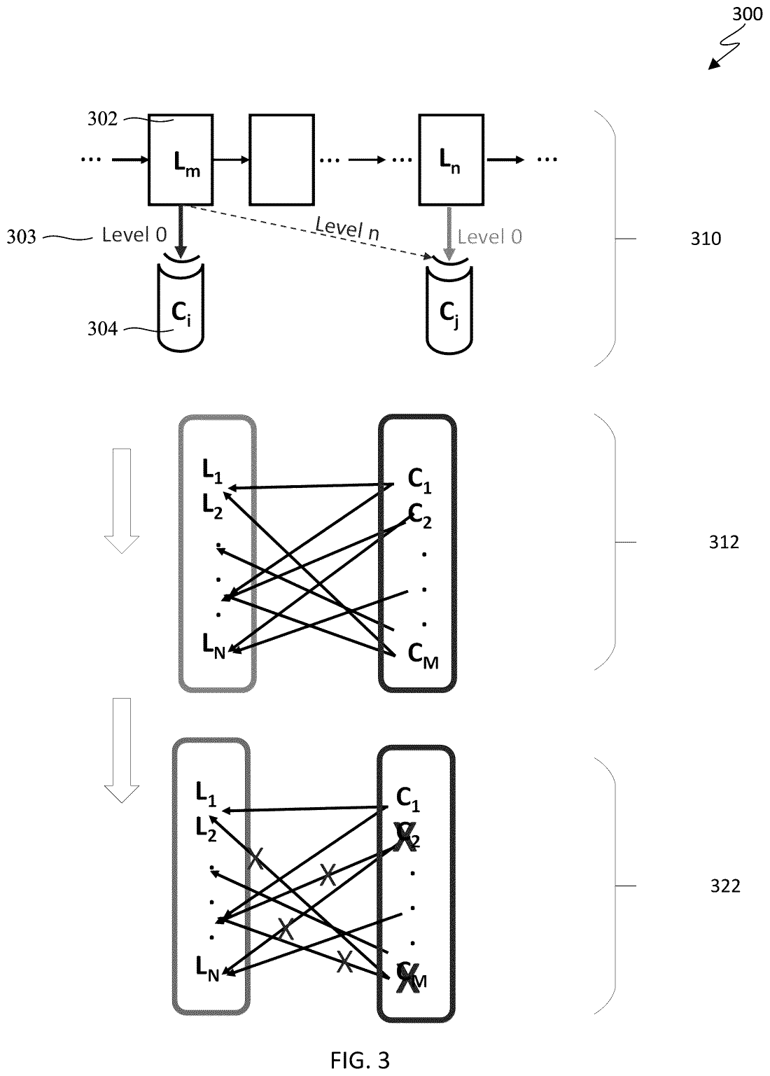

FIG. 3 is a diagram illustrating bipartite graph mapping of latch to checker connection, designated as 300, in accordance with an embodiment of the present invention. Specifically, FIG. 3 illustrates how one embodiment of the present invention determines an optimal set of checkers.

Latches 302 denotes one or more latches (L). The latch starts at Lₘ and ends at Lₙ, where the variable m and n denotes unknown variables, but value of m is typically one.

Level 303 denotes the checking levels between the latches to the checkers. The level of checking can be assigned a weight. However, the weight is not assigned to a particular checker, but to each individual checking operation. The individual checking operation would correspond to an edge in the bipartite graph. This would only be dependent on the following, but is not limited to, a) number of latch stages between covered latch and checker and b) timing margin (slack) determined by static timing analysis. The arrow (between checkers and latches) can be defined as λ (mentioned in FIG. 4).

Checkers 304 are the corresponding checkers (C) to latches 302. The checkers starts at Cᵢ and ends at Cⱼ, where the variable i and j denotes unknown variables, but value of i is typically, 1.

Section 310 illustrates the beginning step of the process where all latches and checkers are present utilizing bipartite graphing method. The bipartite graph mapping reveals the latch to checker connection. It is noted that edges connect checkers to latches per graph and latch is being checked by the checking with the corresponding edge.

Furthermore, the edges are weighted by checking level, for example, the lower the level, the higher the weight.

Section 312 illustrates the mapping between latch to checker, which includes redundant checkers. This section may the following activity, determining duplicate checking logic and eliminating those checkers whose latches are already protected by other checkers. It is noted that not all checkers check all latches. For example, C₁ may only check L₁ to Lⱼ and not necessary all latches up to Lₙ.

Section 322 illustrates the minimum set of checkers that covers the latches (after removal). It is noted that the minimum number of checkers can be reduced by utilizing a vertex cover in a hypergraphs computation (i.e., finding a vertex cover, aka hitting set, in graph theory). However, the result computation will be an approximate solution.

FIG. 4 is a high-level flowchart illustrating the process of IC design environment 100, designated as 400, in accordance with one embodiment of the present invention.

Block 402 denotes the step of static logic analysis. This step involves a logic analysis of the proposed IC design. The analysis may include, but is not limited to, timing analysis (via static timing analysis) and error checking. STA (static timing analysis) can be defined as a timing verification that ensures that various circuiting timing are meeting the various requirements (timing). It is noted that an IC design/programming tool, such as, IBM©'s InsighTER tool may be used for this step (static analysis), but any existing tool may also be used.

Block 404 denotes the step of generating bipartite graph from the prior step. The nodes of the graphs may include latches and checkers. There are checking levels relating to individual checking operation between the latches (L) and checkers (C). This checking level is denoted by λ. Thus, the latches, checkers and checking level are all represented by its own “node.” The set of latches can include L₀ all the way to Lₘ₋₁. The set of checkers includes a C₀ all the way to Cₙ. The set of checking level can include λ₀ to λₘₙ.

Block 406 denotes the step of determining checker set cover, denoted as, C′. This process involves optimizing the bipartite graph based on the pseudo equation:

G(Vertices:V(L,C),Weighted Edges: E(λ)),
where “G” stands for graph optimization, V denotes vertices, L denotes Latches, C denotes Checkers, individual checking operation level is denoted by a, and weighted edges is denoted by E.

However, if a system (instructed by the user/designer) performs the step of block 406 in a “checker oblivious” manner (arrow 407), the system may not detect/select the timing critical checker (i.e., C_{tc}). There is a type of checker that not only checks for soft errors but also checks for timing critical parts. Certain performance analysis may require a processor to perform a computing task within a certain clock cycle. However, there might be issues within the computing task that is done with a certain clock cycle, which produces a timing error. Thus, checkers that check for timing errors can be called “timing critical checkers.” For example, a processor with 5 Ghz running 1 volt may be able to perform the computation task within 200 picoseconds. However, if the voltage is lower to 0.7 volts, then the same process clocked at 5 Ghz may not be able to perform the same computation and may have to change the clock cycle/speed down to 4 Ghz. Essentially, timing critical checkers (C_{tc}) are checking near/close to the edge of the timing errors. Thus, it is necessary to include the timing critical checkers (may be obtained through measurement and/or experimentation) in the checker set cover.

Other checkers may include a different list of optimal checkers that may depend on selected operating voltage (and frequency range).

In a preferred embodiment, as denoted by arrow 407, the timing critical checkers should be preselected and perform the analysis on the remaining checker (i.e., non-timing critical checkers). By pre-selecting the timing critical checkers, the soft errors and timing critical errors can be addressed. For example, if there are 10 checkers, (C₀ to C₉) but only C₂ and C₅ are critical. Users would note what latches (e.g., L₁ and L₃) are being selected C₂ and C₅. Thus, users would identify the remaining latches and checkers for the set cover.

Block 408 denotes the step of evaluating latch activity for representative benchmarks. This activity may be expressed by a pseudo-equation:

Gₛₜₐₜ₋ₒₚₜ=G(V(L,C′),E(V′)) where C_{tc}∈C′,
where Gₛₜₐₜ₋ₒₚt denotes “statically optimized” the latch-check graph (i.e., bipartite graph), G denotes the previous graph (i.e., not optimized) from block 406 and C_{tc}∈C′ denotes that C_{tc} is an element of C′. This optimization is performed without any workloads. Thus, if a latch exists, then it is to be protected.

It is noted that optimizing the bipartite graph can be NP-hard (i.e., proving the selected checker list is close to the theoretical optimal). No known solution exists that can compute in real polynomial time. The optimal checker selection problem is computationally infeasible which requires heuristics (presented as various embodiments) to be implemented in a real system. While the proposed embodiments work well in most cases, the approximation algorithms are 2-approximate, which means that it is possible for the theoretical optimal to be 2X (twice) better than the approximation. Thus, “set cover” (from block 406) can address the Vertex Cover in Hypergraph problem.

Thus, there are other processes (as other embodiments) for which the checker selection can be based. First process (as embodiment one), Level, is a process at which latch is being checked based on priority level (e.g., low, medium and high priority). For example, Level 0 checkers are accorded highest priority. It is noted that priority level assignment is dependent on the user/designer.

The second process (second embodiment), Fanout, is related to the number of latches protected by a checker. It is noted that number of latches protected by a checker can be set by the user/designer.

The third process (third embodiment), Hybrid selection criteria, is where checkers belonging to the same level are selected in order of their fanout. It is noted fanout order can be set by the user/designer.

Blocks 402, 404, 406 and 408 can be summarized as a non-dynamic operation/analysis. Thus, block 410 would be the start of a dynamic analysis process which would include arrow 416. Block 414 would denote the result of the analysis process (after meeting a convergence criteria).

Block 410 denotes the step of initializing C_{ACT} equals to C′. Essentially, this process is to determine inactive and/or active latches as denoted by the pseudo-equation:

For Each Lᵢ in L:

If Act (Lᵢ)>f(α,ω) Then Lᵢ∈L_{ACT},

where Act denotes a function to determine whether Lᵢ is an active latch based on the active latch requirement based on the latch activity function, f(α, ω). The next paragraph will explain how latches are chosen.

### How are Inactive Latches Chosen?

Latch activity across the entire design is analyzed for a set of representative benchmarks and ‘inactive’ latches are marked:

Inactive latches are determined by an activity threshold parameter (α, ω):
α—If a latch switches for more than α % of the total execution period, it is said to be active;
ω—a latch is active if it has nonzero switching activity for more then ω % of the total number of evaluated workloads (W); and
α=0 and ω=1/W is the most conservative configuration that ensures latches which are active for even a single cycle for a single workload are to be protected.

Derated latches are latches that are not prone to various errors and not vulnerable to errors. The derated latches belongs to a set that is denoted by L-L_{ACT}. Essentially, this just means that derated latches do not belong in the set of L_{ACT}.

Furthermore, the process of removing checkers correlating to the derated latches can be performed before the next step (decision block 412).

Decision block 412 denotes the step of determining whether the values of L_{ACT} and C_{ACT} are unchanged from the previous iteration. If the values of L_{ACT} and C_{ACT} have changed then the process repeats (“No” branch, returning to block 404 to repeat the optimization process). Otherwise, if the values of L_{ACT} and C_{ACT} have not changed (from previous iterations) then the process can proceed (“Yes” branch) to block 414 (i.e., final, and optimized design).

In some embodiments, the criterion for convergence is when the final set of optimized checkers remain unchanged for two or more iterations of the static and dynamic checker optimization steps.

Block 414 denotes the result (i.e., convergence has occurred) from the IC design process. This can be illustrated by a pseudo-equation:

G_{dyn-opt}=G(V(L_{ACT},C_{ACT}),E(λ_{ACT}))),
where G_{dyn.opt} denotes dynamically optimized graph.

FIG. 5 is a high-level flowchart illustrating the process of IC component 111, designated as 500, in accordance with another embodiment of the present invention.

Block 502 denotes the step of performing static analysis on the processor design, wherein the processor design includes one or more latches and one or more checkers. This step can be expounded to include the following details: i) identify and organize the processor design into sets of timing paths, wherein the timing paths are associated with the one or more checkers and the one or more latches; ii) calculate delay of each of the sets of timing paths; iii) validating all path delays of the sets of timing paths conform to timing constraints; and iv) identify and list the one or more checkers and the one or more latches based on all of the path delays of the sets of timing paths that has conformed.

Block 504 denotes the step of generating mapping between the one or more latches and the one or more checkers. This step can be expounded to include the following details: i) generating a bipartite graph mapping between the one or more checkers and the one or more latches; ii) generating one or more checking levels between the one or more checkers and the one or more latches, wherein the one or more checking level is an individual checking operation between a checker and a latch; and iii) assigning one or more weights to one or more edges of the one or more checking levels, wherein the one or more weights depends on, a) number of latch stages between a covered latch and the checker or b) timing margin determined by static timing analysis.

Block 506 denotes the step of determining checker set cover based on the mapping. This step can be expounded to include the following details: i) assigning a priority level to the one or more weights, wherein the priority level includes low, medium and high priority; and ii) optimizing the bipartite graph mapping based on one or more vertices of the one or more latches and of the one or more checkers and the one or more weight edges.

Furthermore, block 506 can include the step of preselecting timing critical checkers from the one or more checkers. By pre-selecting timing critical checkers, the present invention can determine a unified set of checkers for timing critical and SER vulnerate latches (i.e., combining it with the features of optimizing a list of timing checkers depending on voltages and/or frequency range and pre-silicon static timing analysis).

Block 508 denotes the step of determining redundant checkers based on checker activity. This step can be expounded to include the following details: i) determining whether non-timing critical checkers are active based on an activity threshold parameters, α and ω, wherein a denotes an occurrence when latch switches for more than α % of the total execution period and ω denotes an occurrence when an active latch has non-zero switching activity for more than ω % of the total number of evaluated workloads; and ii) outputting a list of the redundant checkers based on non-active checkers.

Block 510 denotes the step of eliminating redundant checkers. This step can be expounded to include the following details: i) removing the redundant checkers from the set cover.

Block 512 denotes the step of determining whether convergence criteria has been met. This step can be expounded to include the following details: iteratively repeating a step of, i) determining the checker set cover, ii) preselecting timing critical checkers from the one or more checkers, iii) determining redundant checkers based on checker activity and iv) eliminating redundant checkers until the set cover meets the converge criteria.

In another embodiment, the process of FIG. 5 can be expressed in an alternative summary:
constructing a mapping from latches to checkers;
assigning each latch-to-checker mapping a weight based on criteria that may include:
   vulnerability of associated latches to soft errors;
   overlap (redundancy) with other latches;
   number of latches checked by the checker;
   number of latch stages between covered latch and checker;
   switching activity of latches under representative workloads; and
   timing margin (slack) determined by static timing analysis;
eliminating redundant or low-weighted checkers based on a weight threshold; and repeating the analysis with remaining checkers, iterating until convergence to an optimal set.

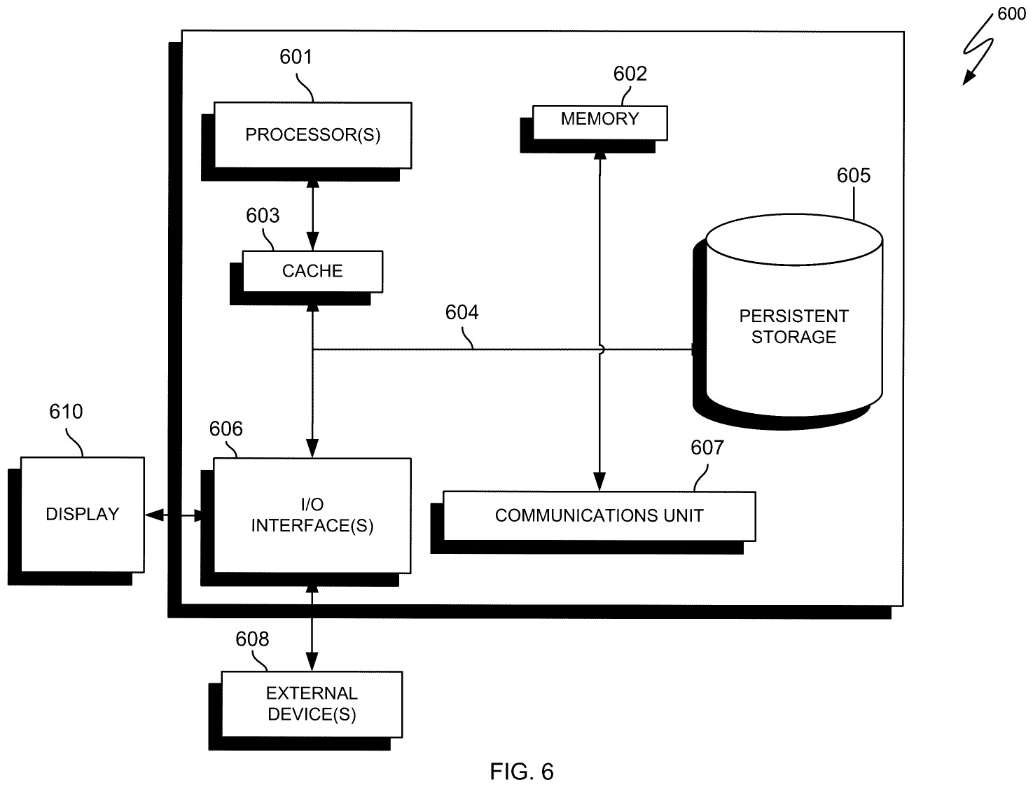

FIG. 6 depicts a block diagram, designated as 600, of components of a server computer capable of executing the suit management component 111 within exoskeleton management environment 600, in accordance with an embodiment of the present invention. It should be appreciated that FIG. 6 provides only an illustration of one implementation and does not imply any limitations with regard to the environments in which different embodiments may be implemented. Many modifications to the depicted environment may be made.

It is to be understood that embodiments of the present invention may be executed inside a cloud-computing infrastructure and is not limited to network servers.

FIG. 6 includes processor(s) 601, cache 603, memory 602, persistent storage 605, communications unit 607, input/output (I/O) interface(s) 606, and communications fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processor(s) 601 by holding recently accessed data, and data near recently accessed data, from memory 602.

Program instructions and data (e.g., software and data x10) used to practice embodiments of the present invention may be stored in persistent storage 605 and in memory 602 for execution by one or more of the respective processor(s) 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605. IC component 111 can be stored in persistent storage 605 for access and/or execution by one or more of the respective processor(s) 601 via cache 603.

Communications unit 607, in these examples, provides for communications with other data processing systems or devices. In these examples, communications unit 607 includes one or more network interface cards. Communications unit 607 may provide communications through the use of either or both physical and wireless communications links. Program instructions and data (e.g., IC component 111) used to practice embodiments of the present invention may be downloaded to persistent storage 605 through communications unit 607.

I/O interface(s) 606 allows for input and output of data with other devices that may be connected to each computer system. For example, I/O interface(s) 606 may provide a connection to external device(s) 608, such as a keyboard, a keypad, a touch screen, and/or some other suitable input device. External device(s) 608 can also include portable computer readable storage media, such as, for example, thumb drives, portable optical or magnetic disks, and memory cards. Program instructions and data (e.g., Satellite management component 111) used to practice embodiments of the present invention can be stored on such portable computer readable storage media and can be loaded onto persistent storage 605 via I/O interface(s) 606. I/O interface(s) 606 also connects to display 610.

Display 610 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### ALTERNATIVE EMBODIMENTS AND COMMENTS

Alternatively, the proposed concept/steps/methods and systems may be summarized in a nutshell in the following clauses:
System and method for eliminating redundant latch parity checkers while preserving the original level of RAS coverage comprising:
   constructing a mapping from latches to checkers;
   assigning each checker a weight based on criteria that may include (among other things);
   vulnerability of associated latches to soft errors;
   overlap (redundancy) with other latches;
   number of latches checked by the checker;
   number of latch stages between covered latch and checker;
   switching activity of latches under representative workloads;
   timing margin (slack) determined by static timing analysis;
   eliminating redundant or low-weighted checkers based on a weight threshold; and
   repeating the analysis with remaining checkers, iterating until convergence to an optimal set.

In another embodiment, the proposed concepts may be summarized by the following clauses:
System and method for eliminating redundant latch parity checkers while preserving the original level of RAS coverage comprising:
   Determining the optimal set of checkers corresponding to detecting SER-induced errors in latches.
   Determining the optimal set of checkers corresponding to timing-critical latches.
   Optimizing list of timing checkers depending on voltage (and/or frequency) range and pre-silicon static timing analysis (407 from FIG. 4).
   Determining a unified set of checkers for timing critical and SER-vulnerable latches (termed as static checker optimization) (combines 406 and 407 of FIG. 4).
   Eliminating latch checkers based on latch switching activity determined at runtime (termed as runtime checker optimization).
   Iteratively running successive static and runtime optimization steps until convergence to an optimal list of checkers for the given processor configuration.

In some embodiments, the proposed concepts may be summarized by the following clauses:
The logic design is analyzed statically to determine the list of latches and their corresponding checkers.
   The logic design can comprise of an entire processor, a single core, or even a single unit/set of macros.
The latches and checkers are mapped to a bipartite graph and the minimum set of checkers that cover all latches (checker set cover) is determined.
   The problem is NP-hard, various approximate heuristics can be adopted as possible embodiments.
Checker selection can depend on criteria such as the level of checking or fanout of checkers.
Timing critical checkers and checking logic deemed by designers to be critical are also necessarily included.
   Checkers corresponding to timing-critical latches are deemed to be critical depending on pre-silicon static timing analysis and post-silicon voltage scaling.
   Different list of optimal checkers possible depending on selected operating voltage (and frequency range).
Latch activity across the entire design is analyzed for a set of representative benchmarks and ‘inactive’ latches are marked.
   Inactive latches are determined by an activity threshold parameters (α, ω):
      α—If a latch switches for more than α % of the total execution period, it is said to be active.
      ω—If a latch is active if it has nonzero switching activity for more then ω % of the total number of evaluated workloads (W).
   α=0, ω=1/W is the most conservative configuration that ensures latches which are active for even a single cycle for a single workload are to be protected.
A new set of latches minus the inactive latches are arrived at and the corresponding checker set cover is determined.
The process is iteratively repeated until convergence of the selected checker set cover across static and dynamic evaluations.
Dynamically disabling checkers depending on workload (power down or clock gate individual checkers or data switching).

What is claimed is:

1. A method for optimizing error-checking logic in a processor design, method comprising:
performing static analysis on the processor design, wherein the processor design includes one or more latches and one or more checkers;
generating mapping between the one or more latches and the one or more checkers;
determining checker set cover based on the mapping;
preselecting timing critical checkers from the one or more checkers;
determining redundant checkers based on checker activity;
eliminating redundant checkers; and
determining whether convergence criteria has been met.

2. The method of claim 1, wherein performing the static analysis further comprises:
identify and organize the processor design into sets of timing paths, wherein the timing paths are associated with the one or more checkers and the one or more latches;
calculate delay of each of the sets of timing paths;
validating all path delays of the sets of timing paths conform to timing constraints; and
identify and list the one or more checkers and the one or more latches based on all of the path delays of the sets of timing paths that has conformed.

3. The method of claim 1, wherein generating mapping further comprises:
generating a bipartite graph mapping between the one or more checkers and the one or more latches;
generating one or more checking levels between the one or more checkers and the one or more latches, wherein the one or more checking level is an individual checking operation between a checker and a latch; and
assigning one or more weights to one or more edges of the one or more checking levels, wherein the one or more weights depends on, i) number of latch stages between a covered latch and the checker or ii) timing margin determined by static timing analysis.

4. The method of claim 3, wherein determining the checker set cover further comprises:
assigning a priority level to the one or more weights, wherein the priority level includes low, medium and high priority; and
optimizing the bipartite graph mapping based on one or more vertices of the one or more latches and of the one or more checkers and the one or more weight edges.

5. The method of claim 1, wherein determining the redundant checkers based on checker activity further comprises:
determining whether non-timing critical checkers are active based on an activity threshold parameters, α and ω, wherein a denotes an occurrence when latch switches for more than α % of the total execution period and ω denotes an occurrence when an active latch has non-zero switching activity for more than ω % of the total number of evaluated workloads; and
outputting a list of the redundant checkers based on non-active checkers.

6. The method of claim 1, wherein eliminating checkers further comprises:
removing the redundant checkers from the set cover.

7. The method of claim 1, wherein determining whether convergence criteria have been met further comprises:
iteratively repeating a step of, i) determining the checker set cover, ii) preselecting timing critical checkers from the one or more checkers, iii) determining redundant checkers based on checker activity and iv) eliminating redundant checkers until the set cover meets the converge criteria.

8. A computer program product for optimizing error-checking logic in a processor design, the computer program product comprising:
one or more computer-readable storage media having computer-readable program instructions stored on the one or more computer-readable storage media said program instructions executes a computer-implemented method comprising the steps of:
performing static analysis on the processor design, wherein the processor design includes one or more latches and one or more checkers;
generating mapping between the one or more latches and the one or more checkers;
determining checker set cover based on the mapping;
preselecting timing critical checkers from the one or more checkers;
determining redundant checkers based on checker activity;
eliminating redundant checkers; and
determining whether convergence criteria has been met.

9. The computer program product of claim 8, wherein performing the static analysis further comprises:
identify and organize the processor design into sets of timing paths, wherein the timing paths are associated with the one or more checkers and the one or more latches;
calculate delay of each of the sets of timing paths;
validating all path delays of the sets of timing paths conform to timing constraints; and
identify and list the one or more checkers and the one or more latches based on all of the path delays of the sets of timing paths that has conformed.

10. The computer program product of claim 8, wherein generating mapping further comprises:
generating a bipartite graph mapping between the one or more checkers and the one or more latches;
generating one or more checking levels between the one or more checkers and the one or more latches, wherein the one or more checking level is an individual checking operation between a checker and a latch; and
assigning one or more weights to one or more edges of the one or more checking levels, wherein the one or more weights depends on, i) number of latch stages between a covered latch and the checker or ii) timing margin determined by static timing analysis.

11. The computer program product of claim 10, wherein determining the checker set cover further comprises:
assigning a priority level to the one or more weights, wherein the priority level includes low, medium and high priority; and
optimizing the bipartite graph mapping based on one or more vertices of the one or more latches and of the one or more checkers and the one or more weight edges.

12. The computer program product of claim 8, wherein determining the redundant checkers based on checker activity further comprises:
determining whether non-timing critical checkers are active based on an activity threshold parameters, α and ω, wherein a denotes an occurrence when latch switches for more than α % of the total execution period and ω denotes an occurrence when an active latch has non-zero switching activity for more than ω % of the total number of evaluated workloads; and
outputting a list of the redundant checkers based on non-active checkers.

13. The computer program product of claim 8, wherein eliminating checkers further comprises:
removing the redundant checkers from the set cover.

14. The computer program product of claim 8, wherein determining whether convergence criteria have been met further comprises:
iteratively repeating a step of, i) determining the checker set cover, ii) preselecting timing critical checkers from the one or more checkers, iii) determining redundant checkers based on checker activity and iv) eliminating redundant checkers until the set cover meets the converge criteria.

15. A system for optimizing error-checking logic in a processor design, the system comprising:
one or more computer processors; and
one or more computer readable storage media having computer-readable program instructions stored on the one or more computer readable storage media, said program instructions executes, by the one or more computer processors, a computer-implemented method comprising the steps of:
performing static analysis on the processor design, wherein the processor design includes one or more latches and one or more checkers;
generating mapping between the one or more latches and the one or more checkers;
determining checker set cover based on the mapping;
preselecting timing critical checkers from the one or more checkers;
determining redundant checkers based on checker activity;
eliminating redundant checkers; and
determining whether convergence criteria has been met.

16. The system of claim 15, wherein performing the static analysis further comprises:
identify and organize the processor design into sets of timing paths, wherein the timing paths are associated with the one or more checkers and the one or more latches;
calculate delay of each of the sets of timing paths;
validating all path delays of the sets of timing paths conform to timing constraints; and
identify and list the one or more checkers and the one or more latches based on all of the path delays of the sets of timing paths that has conformed.

17. The system of claim 15, wherein generating mapping further comprises:
generating a bipartite graph mapping between the one or more checkers and the one or more latches;
generating one or more checking levels between the one or more checkers and the one or more latches, wherein the one or more checking level is an individual checking operation between a checker and a latch; and
assigning one or more weights to one or more edges of the one or more checking levels, wherein the one or more weights depends on, i) number of latch stages between a covered latch and the checker or ii) timing margin determined by static timing analysis.

18. The system of claim 17, wherein determining the checker set cover further comprises:
assigning a priority level to the one or more weights, wherein the priority level includes low, medium and high priority; and
optimizing the bipartite graph mapping based on one or more vertices of the one or more latches and of the one or more checkers and the one or more weight edges.

19. The system of claim 15, wherein determining the redundant checkers based on checker activity further comprises:
determining whether non-timing critical checkers are active based on an activity threshold parameters, α and ω, wherein a denotes an occurrence when latch switches for more than α % of the total execution period and ω denotes an occurrence when an active latch has non-zero switching activity for more than ω % of the total number of evaluated workloads; and
outputting a list of the redundant checkers based on non-active checkers.

20. The system of claim 15, wherein determining whether convergence criteria have been met further comprises:
iteratively repeating a step of, i) determining the checker set cover, ii) preselecting timing critical checkers from the one or more checkers, iii) determining redundant checkers based on checker activity and iv) eliminating redundant checkers until the set cover meets the converge criteria.
